(19) United States
(12) Patent Application Publication
(10) Pub. No.: US 2015/0095533 A1
(43) Pub. Date: Apr. 2, 2015

(54) ELECTRONIC DEVICE HAVING TWO WIRELESS COMMUNICATION COMPONENTS

(71) Applicants: John J. VALAVI, Hillsboro, OR (US); Prosenjit GHOSH, Portland, OR (US)

(72) Inventors: John J. VALAVI, Hillsboro, OR (US); Prosenjit GHOSH, Portland, OR (US)

(21) Appl. No.: 14/040,075

(22) Filed: Sep. 27, 2013

(51) Int. Cl. G06F 13/42

(52) U.S. Cl. CPC G06F 13/4286
USPC 710/106

(57) ABSTRACT

An electronic device may include a first wireless communication component and a second wireless communication component. The first wireless communication component is to operate (or communicate) using a first protocol, and to receive a wireless signal from another device by the first protocol. The second wireless communication component is to operate (or communicate) using a second protocol, and to begin communicating with the another device using the second protocol in response to receiving a trigger signal.

### BACKGROUND

1. Field

Embodiments may relate to an electronic device that has a first wireless communication component and a second wireless communication component.

2. Background

An electronic device may physically couple with other devices, such as docking stations, in order to communicate data and/or obtain/provide power. For example, a laptop computer may physically dock with a docking station in order to exchange data.

A user may desire to connect the electronic device to the docking station, to communicate data between the electronic device and another device, etc. A user may also wish to connect the electronic device to the docking station in order to connect to more devices such as more input/output (I/O) devices, displays, etc.

### BRIEF DESCRIPTION OF THE DRAWINGS

Arrangements and embodiments may be described in detail with reference to the following drawings in which like reference numerals refer to like elements and wherein:

FIG. 1 shows an electronic device according to an example embodiment;

FIG. 2 shows another device according to an example embodiment;

FIG. 3 is a flowchart showing data communication according to an example embodiment; and

FIG. 4 is a flowchart showing data communication according to an example embodiment.

### DETAILED DESCRIPTION

In the following detailed description, like numerals and characters may be used to designate identical, corresponding and/or similar components in differing figure drawings. Further, in the detailed description to follow, example sizes/models/values/ranges may be given although embodiments are not limited to the same. Where specific details are set forth in order to describe example embodiments, it should be apparent to one skilled in the art that embodiments may be practiced without these specific details.

An electronic device may any one of a mobile terminal, a mobile device, a mobile computing platform, a mobile platform, a laptop computer, a tablet, an ultra-mobile personal computer, a mobile Internet device, a smartphone, a personal digital assistance, a display device, a television (TV), etc. For ease of discussion, the following may discuss a laptop computer, although other electronic devices may be used instead of the laptop computer.

An electronic device may dock (or couple) to a docking station (or dock) in order to perform any of a number of functions. The docking station may contain components that may draw power regardless of whether the docking station is being used by the electronic device or not. For example, a docking station may include a Wireless Gigabit (WiGiG) connector device, a Wireless Fidelity (WiFi) connector device, other high power components, and/or a high power radio. Power may be drained (or drawn) from the docking station when a laptop computer (or any other electronic device) is not physically connected to the docking station.

Arrangements and embodiments may utilize features of the WiGig Specification Version 1.0 (announced in December 2009), the WiGig Specification Version 1.1 (announced in June 2011), the ZigBee Specification 1.0 (availability announced on Jun. 13, 2005) a WiFi Specification, and the Bluetooth Core Specification Version 4.0 (adopted as of Jun. 30, 2010). Arrangements and embodiments may utilize features of other versions of specifications.

The docking station may include a battery that may lose voltage (or power) over time. However, the docking station may need to maintain a power link to connect the docking station with the laptop computer. As one example, a WiGiG link of the docking station may need to remain active (or ON) while waiting for the laptop computer (or other electronic device) to come into vicinity of the docking station and make the wireless connection between the docking station and the electronic device.

A chip that includes components of the WiGiG connector device (or the WiFi connector device) may need to remain active (or ON) in order to establish a wireless connection with the docking station. However, this may reduce a voltage (or life) of a battery that powers the electronic device.

Additionally, the electronic device may have to go through multiple operations in order to establish a wireless connection between the electronic device and the docking station.

Embodiments may provide a first wireless communication component (or first wireless component) and a second wireless communication component (or second wireless component) in an electronic device (or in another device). The first wireless communication component may trigger operation of the second wireless communication component when a wireless signal received from another device is determined to be within a prescribed distance from the electronic device. The prescribed distance may be based on a communication capability of the second wireless communication component, such as a WiGiG connector device, a WiFi connector device or another high powered radio device.

The triggering of the operation of the second wireless communication component may be based on a trigger signal.

In at least one embodiment, the first wireless communication component may activate an element of the second wireless communication component based on a distance between the electronic device and the another device.

In at least one embodiment, the trigger signal may turn on the second wireless communication component.

In at least one embodiment, the first wireless communication component may trigger the second wireless communication component based on location data of the electronic device or the another device.

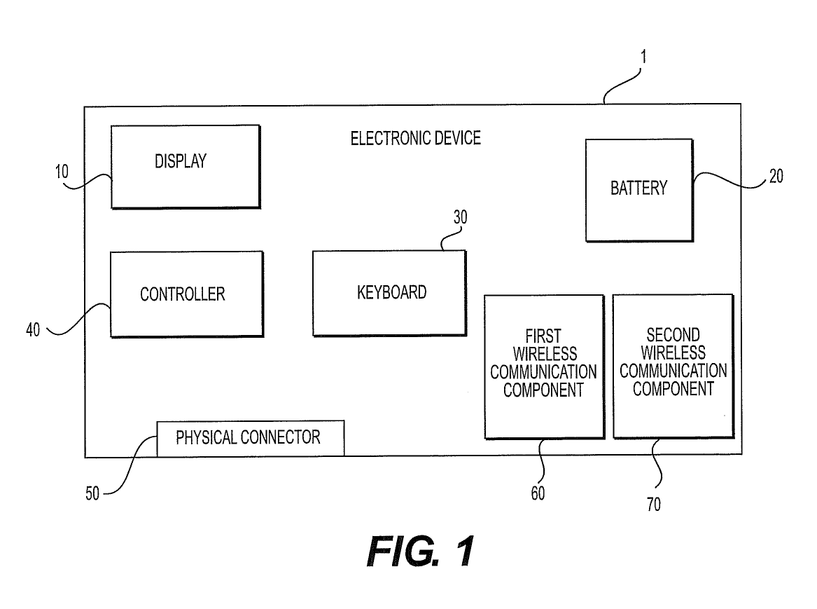

FIG. 1 shows an electronic device according to an example embodiment. Other embodiments and configurations may also be provided.

More specifically, FIG. 1 shows an electronic device 1, such as a laptop computer or a tablet, for example. Other types of electronic devices may also be provided.

The electronic device 1 may include a display 10, a battery 20 (or battery port to receive a battery), a keyboard 30 and a controller 40 (or processor). As shown in FIG. 1, the electronic device 1 may also include a physical connector 50, a first wireless communication component 60 and a second wireless communication component 70. Other components may also be provided at the electronic device.

The physical connector 50 may be for physically connecting the electronic device 1 with another device. The another device may be another electronic device, a docking station etc.

The first wireless communication component 60 may provide wireless communication using a first protocol. The first wireless communication component 60 may be for a low power radio (or the first protocol), such as a low powered radio frequency. Examples of a low power radio may include Bluetooth and Zigbee, for example. Low power radio devices may draw very little power from the connected system, and may help maintain a longer battery life. The first wireless communication component 60 may also be called a device, a module, a unit, etc.

The second wireless communication component 70 may provide wireless communication using a second protocol. The second wireless communication component 70 may be for a high power radio (or the second protocol), such as a high powered radio frequency. Examples of a high power radio may include WiGiG or WiFi, for example. High power radio devices may draw high power, such as in a range of 500 mW-5 W to keep the device running. The second wireless communication component 70 may also be called a device, a module, a unit, etc.

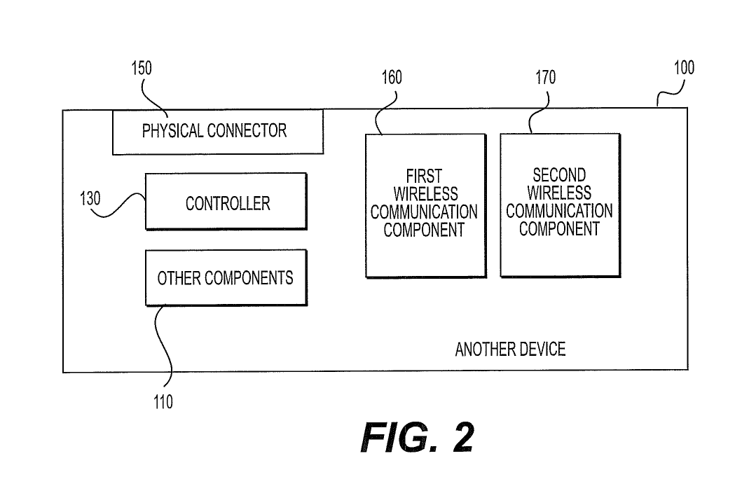

FIG. 2 shows another device according to an example embodiment. Other embodiments and configurations may also be provided.

The another device may be another electronic device, a docking station, etc. For ease of discussion, the following may relate to the another device being a docking station although other devices may be used instead. Additionally, for ease of discussion, a location of the docking station may be fixed (or stationary) and the electronic device may move relative to the docking station.

FIG. 2 shows the another device 100 may include a physical connector 150, a controller 130 (or processor), other components 110, a first wireless communication component 160 and a second wireless communication component 170.

The physical connector 150 may be for physically connecting the another device 100 with an electronic device. For example, the physical connector 150 may be for physically connecting to the physical connector 50 of the electronic device 1.

The first wireless communication component 160 may provide wireless communication using a first protocol. The first wireless communication component 160 may be for a low power radio (or the first protocol), such as a low powered radio frequency. Examples of a low power radio may include Bluetooth and Zigbee, for example. The first wireless communication component 160 may also be called a device, a module, a unit, etc.

The second wireless communication component 170 may provide wireless communication using a second protocol, such as a high powered radio frequency. The second wireless communication component 170 may be for a high power radio (or the second protocol). Examples of a high power radio may include WiGiG or WiFi, for example. The second wireless communication component 170 may also be called a device, a module, a unit, etc.

The first wireless communication component 160 (of the another device 100) may be for wirelessly communicating with the first wireless communication component 60 (of the electronic device 1). The second wireless communication component 170 (of the another device 100) may be for wirelessly communicating with the second wireless communication component 70 (of the another device 100).

The electronic device 1 and the another device 100 may not be able to wirelessly communicate when the devices are greater than a prescribed distance from one another.

When the electronic device 1 is moved closer to the another device 100 (such as the docking station), the first wireless communication component 60 (of the electronic device 1) may wirelessly connect with the first wireless communication component 160 (of the another device 100).

As the electronic device 1 is moved closer to the another device 100 (such as the docking station), then a determining device (such as the controller 40 or a processor) of the electronic device 1 may use information of the low power radio connection to determine whether the electronic device 1 is within a prescribed range (or prescribed distance) of the another device 100 (such as the docking station). The determining device may turn on the second wireless communication component 70 (of the electronic device 1) based on the determination of the determining device. The determining device may turn on an element of the second wireless communication component 70. The determining device of the electronic device 1 may include hardware and/or software to perform the determination. The determining device may include the controller 40 or a processor, for example.

A determining device (such as the controller 130 or a processor) of the another device 100 may use information of the low power radio connection to determine whether the electronic device 1 (such as the docking station) is within a prescribed range (or prescribed distance) of the another device 100. The determining device of the another device 100 may turn on the second wireless communication component 170 (of the another device 100) based on the determination of the determining device. The determining device may turn on an element of the second wireless communication component 70. The determining device of the another device 100 may include hardware and/or software to perform the determination. The determining device may include the controller 130 or a processor, for example.

The electronic device 1 and the another device 100 may separately turn on the high power radio so that they may start a scanning and establish a connection.

Embodiments may use a low power radio (such as the first wireless communication component) as a trigger to turn on high power components (such as the second wireless communication component) of the electronic device (and/or the electronic device).

The electronic device 1 (of FIG. 1) and the another device 100 (of FIG. 2) may use low power communication devices (i.e., the first wireless communication components 60, 160) to establish a wireless connection between the electronic device 1 and the another device 100. Each of the electronic device 1 and the another device 100 may and then separately determine a distance (or distance range) between the electronic device 1 and the another device 100. The determined distance may then be used to turn on high power communication devices (i.e., the second wireless communication components 70, 170) that establish a high bandwidth connection.

Embodiments may use the first wireless communication components 60, 160 (or low power components) as a sensing mechanism (or methodology) to sense when a distance between the electronic device 1 and/or the another device (such as the docking station) is within a prescribed distance (or prescribed range). The prescribed distance may be based on a communication capability of the second wireless communication components 70, 170. Based on the sensing mechanism (or the sensing methodology), the electronic device 1 and the another device 100 may change states of components (such as waking up from a idle state) when the sensed distance is within the prescribed distance range. This may involve waking up components (or activating an element) and preparing components for use when the electronic device 1 is to be used (such as when the lid is opened up from the base) and/or docked.

Embodiments may use the first wireless communication component (or lower power radio) as a trigger to turn on high power components or radios (such as the second wireless communication components). The high power components or radios may be turned on when a determining device determines that a distance between the electronic device 1 and the another device 100 are within a prescribed distance (or range) in order to establish the wireless connection. The determining device (of the electronic device 1) may enable the high power radio (i.e., the second wireless communication component 70) on the electronic device 1. The determining device (of the another device 100) may enable the high power radio (i.e., the second wireless communication component 170) on the another device 100. The determining devices may include logic (at least a portion of which includes hardware) and/or circuitry in order to perform the operations.

Additionally, when the electronic device 1 and the another device 100 are able to sense each other wirelessly, then the another device 100 and the electronic device 1 may wake components (or activate at least one element) and perform procedures such that the components are ready for use.

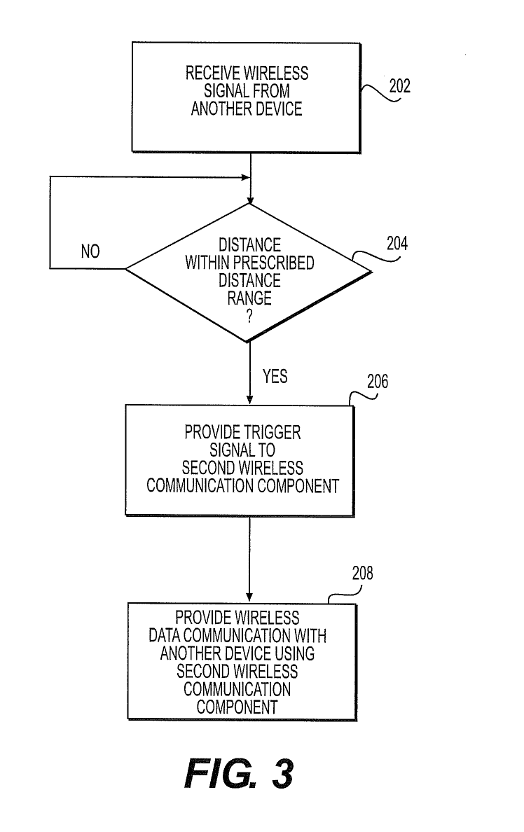

FIG. 3 is a flowchart showing data communication according to an example embodiment. Other embodiments, operations and orders of operations may also be provided.

More specifically, FIG. 3 shows operations for providing wireless data communication between an electronic device (such as the electronic device 1) and another device (such as the another device 100). For ease of discussion, the operations may be discussed with respect to the electronic device 1 although the operations may occur on the another device.

The first wireless communication component may receive a first wireless signal from another device in operation 202. The first wireless signal may be based on a first protocol. A determination may be made (in operation 204) whether a distance between the another device and the electronic device are within a prescribed distance (or range).

One method to determine the distance is by sending a data packet to the other device (i.e., the companion device) and allowing the other device (i.e., the companion device) to loop back the data back to the original device, and use that round trip time to determine the distance. Another method to determine the distance is to determine a strength of the connection between the two radio devices to determine the distance.

If the determination is NO in operation 204 (i.e., the distance is greater than a prescribed distance), then the first wireless communication component (operating using the first protocol) may continue to receive wireless signals from the another device.

If the determination is YES in operation 204 (i.e., the distance is less than the prescribed distance), then a trigger signal may be provided to the second wireless communication component.

In operation 208, a wireless data communication may be made with another device by using the second wireless communication component (operating using the second protocol). At this point, the electronic device and the another device are within a usable range (or prescribed distance) of the second wireless communication components, and thus wireless data communication may occur between the electronic device and the another device using the second protocol. The two devices may therefore communicate using a high power radio, such as WiGiG or WiFi.

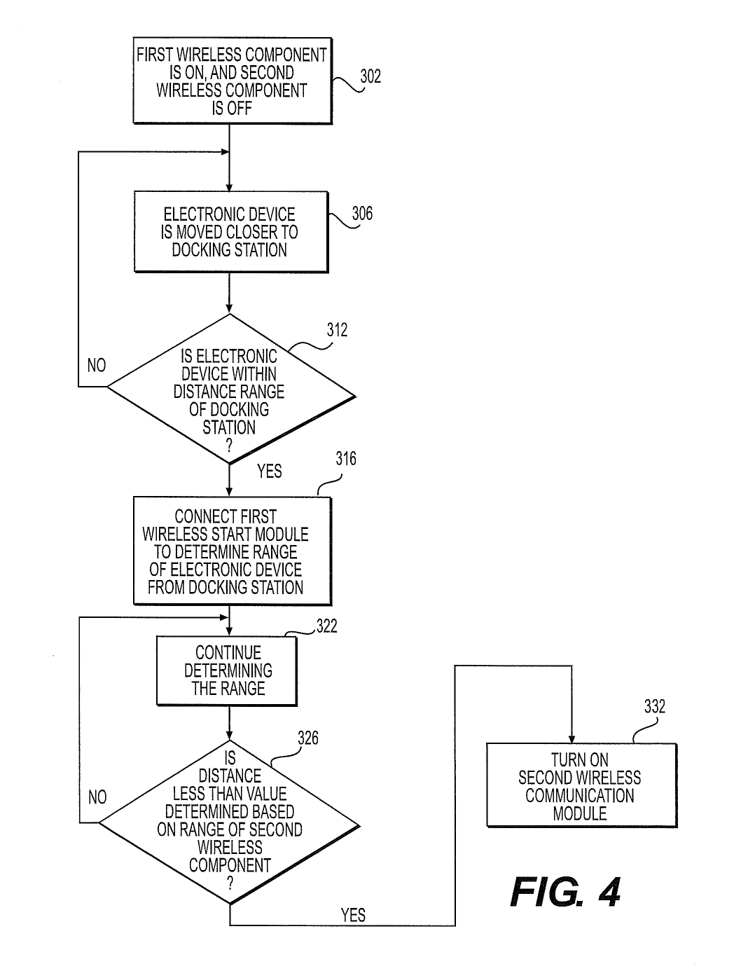

FIG. 4 is a flowchart showing data communication according to an example embodiment. Other embodiments, operations and orders of operations may also be provided.

More specifically, FIG. 4 shows operations for providing wireless data communication between an electronic device (such as the electronic device 1) and another device (such as the another device 100). For ease of discussing, the following operations may be discussed with respect to the electronic device 1 although the operations may occur on the another device.

In operation 302, the first wireless communication component (using the first protocol) may be on, and the second wireless communication component may be off. In at least one embodiment, the second wireless communication component may be provided in a state in which the second wireless communication component is not actively searching for a wireless signal.

The electronic device may be moved closer to the another device in operation 306.

In operation 312, a determination may be made whether a distance between the first wireless communication component and the another device is within a prescribed distance (or range) of the another device (such as the docking station). The prescribed distance may be determined based on a communication capability of the first wireless communication component.

If the determination is NO in operation 312, then the electronic device may continue to be moved closer to the docking station without the second wireless communication component being turned on. On the other hand, if the determination is YES in operation 312 (i.e., the distance is less than the prescribed distance), then operation 316 may occur.

In operation 316, the first wireless communication component may use a start module to determine (or read) whether a distance between the another device and the electronic device are within a prescribed distance (or range).

In operation 322, the distance may be continued to be determined.

In operation 326, a determination may be made (by the determining device) whether a distance between the first communication device and the another device is less than a value determined based on a prescribed distance of the second wireless communication component. If the determination is NO in operation 326 (i.e., the distance is greater than a prescribed distance), then operation may return to operation 322. If the determination is YES in operation 326 (i.e., the distance is less than a prescribed distance), then operations may proceed to operation 332.

In operation 332, the second wireless communication component may be turned on (and operate using the second protocol) for both the electronic device and the another device. At this point, the electronic device and the another device are within a usable range of the second wireless communication components, and thus wireless data communication may occur between the electronic device and the another device. The two devices may therefore communicate using a high power radio, such as WiGiG or WiFi.

In at least one embodiment, an electronic device may operate based on spatial proximity when operating with the first wireless communication component (such as the first wireless communication component 60) and the second wireless communication component (such as the second wireless communication component 70). For example, the first wireless communication component 60 may determine that a wireless signal is being received from a device in a specific area (relative to the electronic device). Based on this determination, a trigger signal may be provided to the second wireless component 70, which may trigger an operation of the second wireless communication component 70.

As one example, the second wireless communication component 70 may provide wireless communication only to an area corresponding to the specific area of the other device. This may be accomplished by using only a specific element (or component) of the second wireless communication device 70 (and not using other elements corresponding to other areas). The specific element may correspond to the specific area or to a specific direction away from the electronic device.

The second wireless communication device 70 may include a plurality of antenna devices with each antenna corresponding to a different direction from the electronic device. Based on a spatial proximity of the other device, only a specific one of the antenna devices (corresponding to the second wireless communication component 70) may be used for wireless communication with the other device. This may avoid excess power being used on the other antennas, which correspond to other areas around the electronic device or other directions from the electronic device. Further, a power of the one antenna may be decreased (from an overall power of the second wireless communication component) in order to avoid excess power being wasted to send signals in different directions.

In at least one embodiment, a power level of the second wireless communication device 70 may be decreased in order to save power. For example, the power level may be decreased for one element (i.e., a specific antenna) of the second wireless communication component 70.

Embodiments may relate to an electronic device. More specifically, embodiments may relate to laptop computers, tablets, and/or other devices that use two or more radio devices (i.e., wireless communication components) to communicate.

An embodiment may also relate to wireless charging. For example, a first wireless communication component may locate a charge surface point (for a wireless charging), and may trigger a second wireless communication component to activate a specific receiver (within a receiver grid or grid) in order to receive wireless signals for wireless charging.

In at least one embodiment, a machine-readable medium (or computer-readable medium) may store a program for controlling circuitry of the wireless communication components. The program may be stored in a memory. In at least one embodiment, the program may be part of a control algorithm for controlling operations of the wireless communication components. The operations may be performed by a processor.

Instructions or code executed by a processor (or controller) may be provided to a memory from a machine-accessible medium, or an external storage device accessible via a remote connection (e.g. over a network via an antenna and/or network interface) providing access to one or more electronically-accessible media, etc. A machine-accessible medium may include any mechanism that provides (i.e., stores and/or transmits) information in a form readable by a machine (e.g. a computer). For example, a machine-accessible medium may include random access memory (RAM), read-only memory (ROM), magnetic or optical storage medium, flash memory devices, electrical, optical, acoustical or other form of propagated signals (e.g. carrier waves, infrared signals, digital signals), etc. In alternative embodiments, hard-wired circuitry may be used in place of or in combination with the instructions or code, and thus embodiments are not limited to any specific combination of hardware circuitry and software instructions.

The program may include code or instructions to perform any of the operations or functions performed in embodiments previously discussed above. Elements of the above described embodiments may be provided in code segments or instructions to perform tasks. The code segments or tasks may be stored in a processor readable medium or transmitted by a computing data signal in a carrier wave over a transmission medium or communication link.

The following examples pertain to further embodiments.

Example 1 is an electronic device to provide wireless communication, comprising: a first wireless communication component is to communicate using a first protocol, and to receive a wireless signal from another device, and a second wireless communication component is to communicate using a second protocol, and the second wireless communication component to begin wirelessly communicating with the another device using the second protocol in response to receiving a trigger signal.

In Example 2, the subject matter of Example 1 can optionally include that the first wireless communication component to trigger the second wireless communication component based on a distance between the electronic device and the another device.

In Example 3, the subject matter of Example 1 can optionally include that the first wireless communication component to activate an element of the second wireless communication component based on a distance between the electronic device and the another device.

In Example 4, the subject matter of Example 1 can optionally include that the first wireless communication component to trigger the second wireless communication component based on location data of the electronic device and the another device.

In Example 5, the subject matter of Example 1 can optionally include that the first wireless communication component to activate a specific element of the second wireless communication component based on a spatial proximity of the another device relative to the electronic device.

In Example 6, the subject matter of Example 5 can optionally include that the specific element to provide wireless communication in a specific direction away from the electronic device.

In Example 7, the subject matter of Example 5 can optionally include that power is to be reduced at the specific element of the second wireless communication component.

In Example 8, the subject matter of Example 1 can optionally include that in response to the first wireless communication component to receive the wireless signal from the another device, the trigger signal is to provide a trigger operation of the second wireless communication component.

In Example 9, the subject matter of Example 1 can optionally include that the trigger signal to turn on the second wireless communication component.

In Example 10, the subject matter of Example 1 can optionally include that the electronic device to determine that the another device is within a prescribed distance from the electronic device.

In Example 11, the subject matter of Example 10 can optionally include that the prescribed distance is based on a communication capability of the second wireless communication component.

In Example 12, the subject matter of Example 1 can optionally include a controller to provide the trigger signal to the second wireless communication component when the another device is within a prescribed distance of the electronic device.

In Example 13, the subject matter of Example 12 can optionally include that the prescribed distance is based on a communication capability of the second wireless communication component.

In Example 14, the subject matter of Example 1 can optionally include that the first wireless communication component is a low power radio device.

In Example 15, the subject matter of Example 14 can optionally include that the second wireless communication component is a high power radio device.

In Example 16, the subject matter of Example 1 can optionally include that the another device is a docking station.

In Example 17, the subject matter of Example 1 can optionally include that the another device is an electronic device.

Example 18 is an electronic device to provide wireless communication, comprising: a first wireless component to receive a first wireless signal from another device using a first protocol, a second wireless component to wirelessly communicate with the another device using a second protocol, and logic, at least a portion of which is hardware, to determine that the another device is located within a prescribed distance from the electronic device, and to provide a trigger signal to the second wireless component when the another device is determined to be within the prescribed distance, and in response to receiving the trigger signal, the second wireless component to provide a wireless communication with the another device.

In Example 19, the subject matter of Example 18 can optionally include that the second wireless component is to be triggered based on a distance between the electronic device and the another device.

In Example 20, the subject matter of Example 18 can optionally include that an element of the second wireless component is to be activated based on a distance between the electronic device and the another device.

In Example 21, the subject matter of Example 18 can optionally include that the second wireless component is to be triggered based on location data of the electronic device or the another device.

In Example 22, the subject matter of Example 18 can optionally include that a specific element of the second wireless component is to be activated based on a spatial proximity of the another device relative to the electronic device.

In Example 23, the subject matter of Example 22 can optionally include that the specific element to provide wireless communication in a specific direction away from the electronic device.

In Example 24, the subject matter of Example 22 can optionally include that power is to be reduced at the specific element of the second wireless component.

In Example 25, the subject matter of Example 18 can optionally include that the second wireless component is to be turned on by the trigger signal.

In Example 26, the subject matter of Example 18 can optionally include that the prescribed distance is based on a communication capability of the second wireless component.

In Example 27, the subject matter of Example 18 can optionally include that the logic includes a controller to determine when the another device is within the prescribed distance of the electronic device.

In Example 28, the subject matter of Example 18 can optionally include that the prescribed distance is based on a communication capability of the second wireless component.

In Example 29, the subject matter of Example 18 can optionally include that the first wireless component is a low power radio device.

In Example 30, the subject matter of Example 29 can optionally include that the second wireless component is a high power radio device.

In Example 31, the subject matter of Example 18 can optionally include that the another device is a docking station.

In Example 32, the subject matter of Example 18 can optionally include that the another device is an electronic device.

Example 33 is a computer-readable medium comprising one or more instructions that when executed on a processor to configure the processor to perform one or more operations to: determine, by using a first wireless component, that another device is located within a prescribed distance from an electronic device, provide a trigger signal to a second wireless component when the another device is determined to be within the prescribed distance, and provide wireless communication via the second wireless component in response to receiving the trigger signal.

In Example 34, the subject matter of Example 33 can optionally include that the processor to perform operations for the first wireless component to trigger the second wireless component based on a distance between the electronic device and the another device.

In Example 35, the subject matter of Example 33 can optionally include that the processor to perform operations for the first wireless component to activate an element of the second wireless component based on a distance between the electronic device and the another device.

In Example 36, the subject matter of Example 33 can optionally include that the processor to perform operations for the first wireless component to trigger the second wireless component based on location data of the electronic device or the another device.

In Example 37, the subject matter of Example 33 can optionally include that the processor to perform operations to activate a specific element of the second wireless component based on a spatial proximity of the another device relative to the electronic device.

In Example 38, the subject matter of Example 37 can optionally include that the specific element to provide wireless communication in a specific direction away from the electronic device.

In Example 39, the subject matter of Example 37 can optionally include that power is to be reduced at the specific element of the second wireless component.

In Example 40, the subject matter of Example 33 can optionally include that the second wireless component to be turned on by the trigger signal.

In Example 41, the subject matter of Example 33 can optionally include that the prescribed distance is based on a communication capability of the second wireless component.

In Example 42, the subject matter of Example 33 can optionally include that the prescribed distance is based on a communication capability of the second wireless component.

In Example 43, the subject matter of Example 33 can optionally include that the first wireless component is a low power radio device.

In Example 44, the subject matter of Example 43 can optionally include that the second wireless component is a high power radio device.

In Example 45, the subject matter of Example 33 can optionally include that the another device is a docking station.

In Example 46, the subject matter of Example 33 can optionally include that the another device is an electronic device.

Example 47 is a method of providing wireless communication comprising: determining, by using a first wireless component, that another device is located within a prescribed distance from an electronic device, providing a trigger signal to a second wireless component when the another device is determined to be within the prescribed distance, and providing wireless communication via the second wireless component in response to receiving the trigger signal.

In Example 48, the subject matter of Example 47 can optionally include that providing the trigger signal to include providing the trigger signal to the second wireless component based on a distance between the electronic device and the another device.

In Example 49, the subject matter of Example 47 can optionally include that providing wireless communication to include to activate an element of the second wireless component based on a distance between the electronic device and the another device.

In Example 50, the subject matter of Example 47 can optionally include that providing the trigger signal to include providing the trigger signal to the second wireless component based on location data of the electronic device or the another device.

In Example 51, the subject matter of Example 47 can optionally include that the first wireless component to activate a specific element of the second wireless component based on a spatial proximity of the another device relative to the electronic device.

In Example 52, the subject matter of Example 51 can optionally include that the specific element to provide wireless communication in a specific direction away from the electronic device.

In Example 53, the subject matter of Example 52 can optionally include that power is to be reduced at the specific element of the second wireless communication component.

In Example 54, the subject matter of Example 51 can optionally include that providing wireless communication to include turning on the second wireless component in response to receiving the trigger signal.

In Example 55, the subject matter of Example 47 can optionally include that the prescribed distance is based on a communication capability of the second wireless component.

In Example 56, the subject matter of Example 47 can optionally include that the prescribed distance is based on a communication capability of the second wireless component.

In Example 57, the subject matter of Example 56 can optionally include that, wherein the first wireless component is a low power radio device.

In Example 58, the subject matter of Example 47 can optionally include that the second wireless component is a high power radio device.

In Example 59, the subject matter of Example 47 can optionally include that the another device is a docking station.

In Example 60, the subject matter of Example 47 can optionally include that the another device is an electronic device.

Example 61 is an electronic device to provide wireless communication, comprising: means for receiving a first wireless signal from another device using a first protocol, means for wirelessly communicating with the another device using a second protocol, and means for determining that the another device is located within a prescribed distance from the electronic device, and for providing a trigger signal when the another device is determined to be within the prescribed distance, and in response to receiving the trigger signal, the means for wirelessly communicating to provide a wireless communication with the another device using the second protocol.

In Example 62, the subject matter of Example 61 can optionally include that the means for wirelessly communicating using the second protocol is to be triggered based on a distance between the electronic device and the another device.

In Example 63, the subject matter of Example 61 can optionally include that an element of the means for wirelessly communicating using the second protocol is to be activated based on a distance between the electronic device and the another device.

In Example 64, the subject matter of Example 61 can optionally include that the means for wirelessly communicating using the second protocol is to be triggered based on location data of the electronic device or the another device.

In Example 65, the subject matter of Example 61 can optionally include that a specific element of the means for wirelessly communicating using the second protocol is to be activated based on a spatial proximity of the another device relative to the electronic device.

In Example 66, the subject matter of Example 61 can optionally include that the specific element to provide wireless communication in a specific direction away from the electronic device.

In Example 67, the subject matter of Example 61 can optionally include that power is to be reduced at the specific element of the means for wirelessly communicating using the second protocol.

In Example 68, the subject matter of Example 61 can optionally include that the means for wirelessly communicating using the second protocol is to be turned on by the trigger signal.

In Example 69, the subject matter of Example 61 can optionally include that the prescribed distance is based on a communication capability of the means for wirelessly communicating using the second protocol.

In Example 70, the subject matter of Example 61 can optionally include that the prescribed distance is based on a communication capability of the second wireless component.

In Example 71, the subject matter of Example 61 can optionally include that the another device is a docking station.

In Example 72, the subject matter of Example 61 can optionally include that the another device is an electronic device.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electronic device to provide wireless communication, comprising:
a first wireless communication component is to communicate using a first protocol, and to receive a wireless signal from another device; and
a second wireless communication component is to communicate using a second protocol, and the second wireless communication component to begin wirelessly communicating with the another device using the second protocol in response to receiving a trigger signal.

2. The electronic device of claim 1, wherein the first wireless communication component to trigger the second wireless communication component based on a distance between the electronic device and the another device.

3. The electronic device of claim 1, wherein the first wireless communication component to activate an element of the second wireless communication component based on a distance between the electronic device and the another device.

4. The electronic device of claim 1, wherein the first wireless communication component to trigger the second wireless communication component based on location data of the electronic device and the another device.

5. The electronic device of claim 1, wherein the first wireless communication component to activate a specific element of the second wireless communication component based on a spatial proximity of the another device relative to the electronic device.

6. The electronic device of claim 5, wherein the specific element to provide wireless communication in a specific direction away from the electronic device.

7. The electronic device of claim 5, wherein power is to be reduced at the specific element of the second wireless communication component.

8. The electronic device of claim 1, wherein in response to the first wireless communication component to receive the wireless signal from the another device, the trigger signal is to provide a trigger operation of the second wireless communication component.

9. The electronic device of claim 1, wherein the trigger signal to turn on the second wireless communication component.

10. The electronic device of claim 1, wherein the electronic device to determine that the another device is within a prescribed distance from the electronic device.

11. The electronic device of claim 10, wherein the prescribed distance is based on a communication capability of the second wireless communication component.

12. The electronic device of claim 1, further comprising a controller to provide the trigger signal to the second wireless communication component when the another device is within a prescribed distance of the electronic device.

13. The electronic device of claim 12, wherein the prescribed distance is based on a communication capability of the second wireless communication component.

14. The electronic device of claim 1, wherein the first wireless communication component is a low power radio device.

15. The electronic device of claim 14, wherein the second wireless communication component is a high power radio device.

16. The electronic device of claim 1, wherein the another device is a docking station.

17. The electronic device of claim 1, wherein the another device is an electronic device.

18. An electronic device to provide wireless communication, comprising:
a first wireless component to receive a first wireless signal from another device using a first protocol;
a second wireless component to wirelessly communicate with the another device using a second protocol; and
logic, at least a portion of which is hardware, to determine that the another device is located within a prescribed distance from the electronic device, and to provide a trigger signal to the second wireless component when the another device is determined to be within the prescribed distance, and in response to receiving the trigger signal, the second wireless component to provide a wireless communication with the another device.

19. The electronic device of claim 18, wherein the second wireless component is to be triggered based on a distance between the electronic device and the another device.

20. The electronic device of claim 18, wherein an element of the second wireless component is to be activated based on a distance between the electronic device and the another device.

21. The electronic device of claim 18, wherein the second wireless component is to be triggered based on location data of the electronic device or the another device.

22. The electronic device of claim 18, wherein a specific element of the second wireless component is to be activated based on a spatial proximity of the another device relative to the electronic device.

23. The electronic device of claim 22, wherein the specific element to provide wireless communication in a specific direction away from the electronic device.

24. A computer-readable medium comprising one or more instructions that when executed on a processor to configure the processor to perform one or more operations to:
determine, by using a first wireless component, that another device is located within a prescribed distance from an electronic device;
provide a trigger signal to a second wireless component when the another device is determined to be within the prescribed distance; and
provide wireless communication via the second wireless component in response to receiving the trigger signal.

25. The computer-readable medium of claim 24, wherein the processor to perform operations for the first wireless component to trigger the second wireless component based on a distance between the electronic device and the another device.

26. The computer-readable medium of claim 24, wherein the processor to perform operations for the first wireless component to activate an element of the second wireless component based on a distance between the electronic device and the another device.

27. The computer-readable medium of claim 24, wherein the processor to perform operations for the first wireless component to trigger the second wireless component based on location data of the electronic device or the another device.

28. The computer-readable medium of claim 24, wherein the processor to perform operations to activate a specific element of the second wireless component based on a spatial proximity of the another device relative to the electronic device.
